(19) United States
(12) Patent Application Publication
(10) Pub. No.: US 2013/0246260 A1
(43) Pub. Date: Sep. 19, 2013

(54) Mobile Payment Transaction System

(71) Applicant: BARCLAYS BANK PLC, London (GB)

(72) Inventors: Loren Oliver Barten, London (GB); Craig Ramsay, Bedfordshire (GB)

(73) Assignee: BARCLAYS BANK PLC, London (GB)

(21) Appl. No.: 13/687,518

(22) Filed: Nov. 28, 2012

(30) Foreign Application Priority Data
Dec. 1, 2011 (GB) 1120701.6

(51) Int. Cl. G06Q 20/36

(52) U.S. Cl. CPC G06Q 20/3674
USPC 705/41; 705/44

(57) ABSTRACT

A payment transaction system including a payment authentication token associated with a customer; and a payment platform associated with the authentication token, the payment platform storing a stored value payment account having a pre-paid stored value and information corresponding to a plurality of linked funding accounts. In response to a transaction authentication performed by the authentication token and transaction data associated with the transaction, the payment platform selects the stored value payment account or a linked account, and settles the transaction with the selected account.

### FIELD OF THE INVENTION

The present invention relates to a payment transaction processing and management system and method, and particularly to secure transaction operations by a mobile wallet.

### BACKGROUND OF THE INVENTION

Conventional payment systems are labor-intensive and time consuming for customers. Typically, customers have many different accounts with one or more issuers, and there are delays arising from the customer deciding on the payment account to use to settle a transaction, and from processing and settling payments with the issuer accounts.

What people want is more convenient and efficient control and use of their money. It would be desirable for a customer to consolidate all their accounts onto one card, so that they can make payments from any of their different accounts using one payment account. It would further be desirable for a customer to aggregate the accounts so that they can see everything in one place, in real time and have the transactions automatically categorized. It would also be desirable for a customer to efficiently effect payment from one of the payment accounts without having to switch from one payment account to another prior to the point of payment.

U.S. Pat. No. 5,276,311 issued to Hennige (“Hennige”) discusses one method of consolidating multiple accounts onto one card. In accordance with the method disclosed by Hennige, an electronic multifunction card emulates multiple different account cards.

The PayPal™ payment system allows a customer to store account details, and conduct transactions using the stored account details in conjunction with a login over the Internet, without requiring the account details to be communicated over the Internet for each transaction.

EP Patent No.-A-1,821,249 to Lufthansa/Orbiscom discusses a system for interconnecting payment networks. A master credit card number is associated with a limited-use credit card number for a specific transaction, and the limited use credit card number is used to settle payment with a merchant. This system allows greater control and security over the settlement process, since a separate payment limit may be set on the limited use card number, and there is no need to disclose the master credit card number to the merchant.

U.S. Pat. No. 7,870,071 and U.S. Patent Publication No. 2009/0057396 discuss payment processing systems that provide a token linked to a plurality of payment accounts to complete a purchase.

### STATEMENT OF THE INVENTION

According to the present invention, there is provided a payment transaction system, including a payment authentication token associated with a customer and a payment platform providing a payment account associated with the authentication token. The payment platform stores linked account information corresponding to a plurality of funding accounts associated with the customer and with the payment account. The payment platform also stores stored value payment account information corresponding to a stored value payment account having a pre-paid stored value. In response to a transaction authentication performed by the authentication token and transaction data associated with the transaction, the payment platform is arranged to select one of the stored value payment account and an account associated with the customer, and to settle the transaction with the selected account.

The customer may set or configure one or more rules for automatic account selection based on transaction data, preferably by means of a user interface, such as a mobile app or web-based interface. Additional rules, such as regulatory and/or business rules may also be applied. The platform may then select the one or more accounts automatically based on the transaction data or preset rules, or the customer may select the one or more accounts manually.

In one preferred embodiment, the settlement of the transaction is delayed for a period so that the customer has the opportunity to settle the transaction with a selected account, or the account may be selected automatically if the user does not select within a preset period of time. The user may select the account by means of a user interface, preferably a graphical user interface that provides a graphical representation of each pending transaction and of each of the accounts. The interface allows the user to drag a pending transaction to an account and thereby select the account for settlement of the pending transaction.

The platform may divide a transaction into multiple fractions, with each fraction being settled with a different account. The platform may combine a plurality of transactions into a single settlement with one of the selected accounts. These dividing and/or combining operations may be performed in response to user initiation, or automatically.

The platform may send a report or alert to the customer in response to a transaction, preferably based on one or more alerting rules set by the customer. The report or alert may be sent as an email or SMS, for example.

The platform may automatically categorize a transaction according to one or more predetermined categorization rules, which may be configured by the customer. A report or alert may be sent to the customer based on the categorization of a transaction.

The authentication token may be a card, preferably of an industry standard form factor, or a wireless communication device having a unique identity, for example.

According to another aspect of the present invention, there is provided a payment transaction system that categorizes payment transactions and provides reports to a customer based on the categorizations as the transactions are conducted.

A payment transaction system in an embodiment of the invention may perform one or more of the following functions:
allowing a single card/payment account, with a single PIN, to authorize payment transactions from any one of a plurality of different accounts;
allowing real-time transaction routing;
automatic categorization of transactions, to enable or facilitate category-based transaction routing; and/or
drag and drop transactions—selecting a payment vehicle (e.g. an account) for a transaction, or moving a transaction from one payment vehicle to another, by means of a graphical user interface.

### BRIEF DESCRIPTION OF THE DRAWINGS

There now follows, by way of example only, a detailed description of embodiments of the present invention, with references to the figures identified below.

FIG. 1 is a diagram of an overall payment transaction system in accordance with an embodiment of the invention.

FIG. 2 is a flow diagram of the transaction routing process in accordance with the embodiment disclosed in FIG. 1.

FIGS. 3a, 3b and 3c are diagrams of an account management functionality of the system according to examples of the mobile device.

FIG. 4 is a diagram of an account management functionality of the system.

FIG. 5 is a flowchart of the process of category-based routing according to an embodiment.

FIG. 6 is a diagram of a user controlled transaction routing functionality of the system.

FIG. 7 is a diagram of a straight-through authorization function of the system.

FIG. 8 is a diagram of a holding authorization function of the system.

FIG. 9 is a diagram of a straight-through settlement function of the system.

FIG. 10 is a diagram of a holding settlement function of the system.

FIG. 11 is a diagram of an example of a computer system on which one or more of the functions of the embodiment may be implemented; and

FIG. 12 is a diagram of the computer system of FIG. 11 with a secondary memory.

### DETAILED DESCRIPTION OF THE EMBODIMENTS

Card Payment Background

Card payments are a way of paying for goods and services without cash changing hands; the presentation of the card details and appropriate cardholder authentication guarantee the merchant payment. A conventional card payment system is made up of a number of components including: a cardholder, a merchant, an acquirer, a scheme and a card issuer. As is appreciated by those skilled in the art, the cardholder is the consumer purchasing goods or services with a card, the merchant is selling the goods or services to the consumer, the acquirer is an intermediary that functions to process the transaction on behalf of the merchant and card issuer, the scheme refers to the entity operating a specific transaction protocol (i.e., rules for the interchange) in which the cardholder, merchant, merchant acquirer and card issuer have agreed to participate, and the card issuer is the bank or other entity offering the cards directly to the consumer and ultimately assuming financial liability for the transaction by providing the cardholder with a line of credit.

In the normal process, the cardholder presents his card (or token) to the merchant in order to pay for goods or services rendered; this transaction may take place over any one of a number of channels (in a store or via the Internet, for example). The merchant, through his acquirer, is set up to accept different card types by scheme (Visa®, MasterCard®, Amex®, credit, debit, for example). When a card is presented, the cardholder is authenticated (by Personal Identification Number, PIN, passcode, or Card Verification Value, CV2, for example), subject to channel and merchant capability, and the transaction is then submitted to the merchant's acquirer (referred to herein as “merchant acquirer) for authorization.

Once the transaction is received, the merchant acquirer routes the authorization requesting transaction, in real time, to the relevant scheme based upon card type. The scheme provides isolation between merchant acquirers and card issuers for routing of authorization requests, settlements and funds movement. The merchant acquirer doesn't need to know who the issuer is, just which scheme to route it to, which is determined by the Bank Identification Number (BIN).

The card issuer authorizes the transaction based upon the cardholder's balance and other risk/fraud criteria and returns an authorized message and an authorization code to the scheme, which routes it back to the merchant acquirer who sent it to the merchant. At this point no payment has been made, just confirmation that the funds are available. The ‘open to buy’ value on the cardholders account will also be reduced by the amount of the authorization.

The merchant then confirms the sale, which posts a settlement transaction to the merchant acquirer; this is a mandate to make the payment and move the funds. The settlement transaction is routed between merchant acquirers and issuers via the scheme in a batch mode. Payment to the merchant depends upon their terms with their acquirer but can be daily, weekly or upon receipt of funds from the card issuer. Both issuers and acquirers perform bulk funds transfer with the schemes on a daily basis for all transactions having been settled that day.

Mobile Wallet Payment System

A mobile wallet payment system in accordance with the present invention, referred to as the payment system, performs the role of both acquirer and merchant. The initial card payment transaction is completed between the merchant (via their acquirer and the appropriate scheme) and the payment system acting as a card issuer. In order for the payment system to fund that transaction from a target card account, it acts as a merchant placing a new and possibly different (aggregated or split) transaction, an authorization and a settlement, which will then be routed by the acquiring network to the scheme and onto the target card issuer. The payment system is further configured to select and use a stored value payment account having a pre-paid stored value.

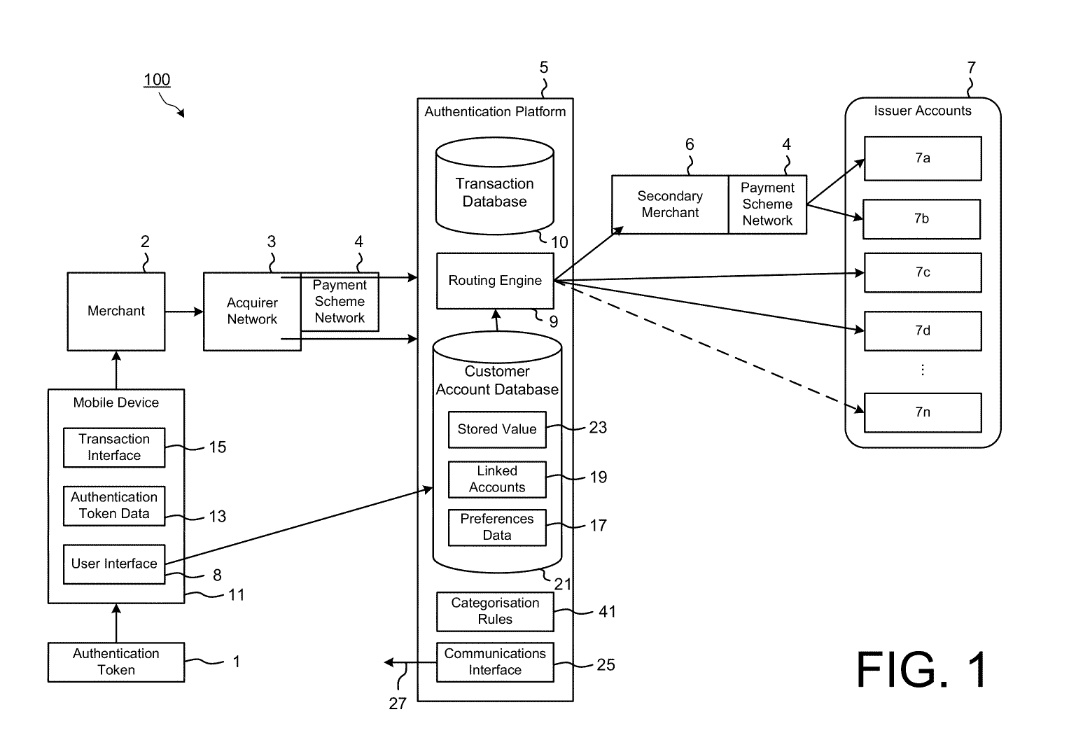

FIG. 1 shows elements of the payment transaction system 100. In accordance with a preferred embodiment, the payment transaction system 100 includes a customer authentication token, which a customer uses to authenticate transactions. The authentication token 1 can take one or more known forms, such as a card with a magnetic stripe and/or embedded chip. Instead of using a single card, the customer may authenticate a transaction using some other authentication token, such as a near field communication (NFC) mobile communication device, a mobile phone or portable computing device, or a biometric authentication device, for example.

The payment transaction system 100 also includes an originating merchant 2, with which the customer initiates payment transactions and which send transaction data, including authentication information. The payment transaction system further includes acquirer networks 3, which process transactions on behalf of originating merchants 2 to a payment scheme network 4 (e.g. Visa® or MasterCard®), and a payment scheme network 4, which handles the processing (settlement) of transactions between the bank of the originating merchants and the payment transaction system 100.

As a card issuer, the payment authentication platform 5 of the payment transaction system 100 receives transactions via the merchant acquirer and payment scheme network 4 before routing them on to target accounts for which the customer has stored account details, as well as performing other functions as described herein. As a merchant, a secondary merchant 6 of the payment transaction system 100 initiates the onward payment to target card issuers (credit or debit) via an Acquirer and the payment scheme network 4.

The payment transaction system 100 also includes target payment vehicles 7. The target payment vehicles comprise administrator systems and interfaces of issuer payment accounts 7a-7n for which the customer has stored details on the payment transaction system 100.

This present payment transaction system 100 links all of a customer's debit, credit and store cards into one payment account, and additionally provides for a pre-paid stored value for efficiently settling predetermined transactions. Funds are transferred to the pre-paid stored value account associated with the customer's mobile wallet from any funding account, such as one of the linked payment accounts, prior to initiating transactions using the mobile wallet. When the stored value account is selected to settle a transaction, the payment authentication platform 5 can take the transaction amount directly from the stored value account, without involving the linked payment accounts at the time of transaction processing.

The payment transaction system 100 is a ‘reverse aggregator’—rather than pulling financial data back from multiple accounts, it provides a single real-time routing of the originating transactions through one platform. The transaction data are recorded by the payment authentication platform 5 in a transaction database 10. Therefore, the payment transaction system 100 is able to report transaction data to the customer as the transaction is performed, rather than by reading transaction data back from the multiple accounts. With additional information on existing direct debits and standing orders, the payment transaction system 100 can provide individuals with a more robust view of what they have spent and are scheduled to spend relative to what they have left in their accounts.

The customer is able to consolidate accounts into one authentication token 1 utilising an ‘Account set-up and Management’ user interface 8 of a computing device 11. In accordance with the disclosed embodiment, the customer's computing device is a mobile device 11, such as a mobile smart phone, that is configured as a mobile electronic wallet and stores authentication token data 13 corresponding to the customer's authentication token 1. The mobile device 11 has a transaction interface 15, such as a contactless payment transaction interface, for communicating with a corresponding interface (not shown) of the originating merchant 2.

The customer inputs account details for each of the accounts that are to be consolidated, which details are transmitted to and stored by the payment authentication platform 5 as customer preferences data 17, and linked account data 19 in a customer account database 21. As mentioned above, the customer account database 21 also stores pre-paid stored value payment account data 23 that can be used by the payment authentication platform 5 to settle transactions directly with the originating merchant 2 instead of using one of the customer's linked, accounts 19. Alternatively, the payment authentication platform 5 selects one of the customer's linked accounts 19 based on the transaction routing information stored as preferences data 17, and the selected account is used to settle a particular transaction.

The customer is able to manipulate the transactional routing of particular transactions via the user interface 8, as will be described in more detail below. A routing engine 9 of the payment authentication platform 5 directs transactions to issuers according to the pre-defined and/or customer defined parameters.

Routing Engine

One feature of the present payment transaction system 100 is that a customer is able to conduct transactions from multiple accounts using a single means of authentication, such as the single authentication token 1 with a single associated PIN or passcode. This provides significantly improved convenience, avoiding the need to remember multiple passwords/PINs. Furthermore, since all transactions for a customer are routed through a single place (e.g. node or platform), additional functionality can be provided that is not possible with conventional transaction systems, as will be described below.

As shown in FIG. 1, the customer is able to manipulate the transactional routing of particular transactions via the ‘Account set-up and Management’ user interface 8 of the mobile device 11. Instead of using the ‘Account set-up and Management’ user interface 8 through the mobile device 11, it is appreciated the interface may be available on the Internet through a web browser of a computing device such as a personal computer.

As authorization and settlement transactions arrive from the acquiring payment scheme network, they arrive at the payment authentication platform 5 of the payment transaction system 100. The routing engine 9 determines how to direct and manipulate the transactions. The routing engine 9 pulls information from a hierarchy of rules—a combination of customer defined rules stored in the preferences data 17 in the customer account database 21, and a system of recommended rules based on predetermined algorithms—in order to determine if the transactions are to be settled using the pre-paid stored value payment account data 23 of the customer's mobile wallet, or if the routing engine 9 is to direct transactions to a selected target payment vehicle 7, referred to as “pass though” transaction settlement. Certain regulatory or business rules may also be applied to govern how this functionality can be used.

The routing engine 9 also decides, based on profile parameters (such as the amount, merchant type, and/or customer profile) how to handle the authorization and settlement transactions, for example: pass them straight through to the target payment vehicle 7 or hold them for a period, such as up to 48 hours. The three option combinations for handling these are as follows:
a. Straight-through authorizations with straight-through settlements;
b. Straight-through authorizations with holding settlements; and
c. Holding authorizations with holding settlements.

The payment authentication platform 5 may issue an alert to the customer, via a communications interface 25 on selected communication channels 27, such as SMS or email, to provide timely and relevant communications regarding their transactional behavior based on preset alert preferences.

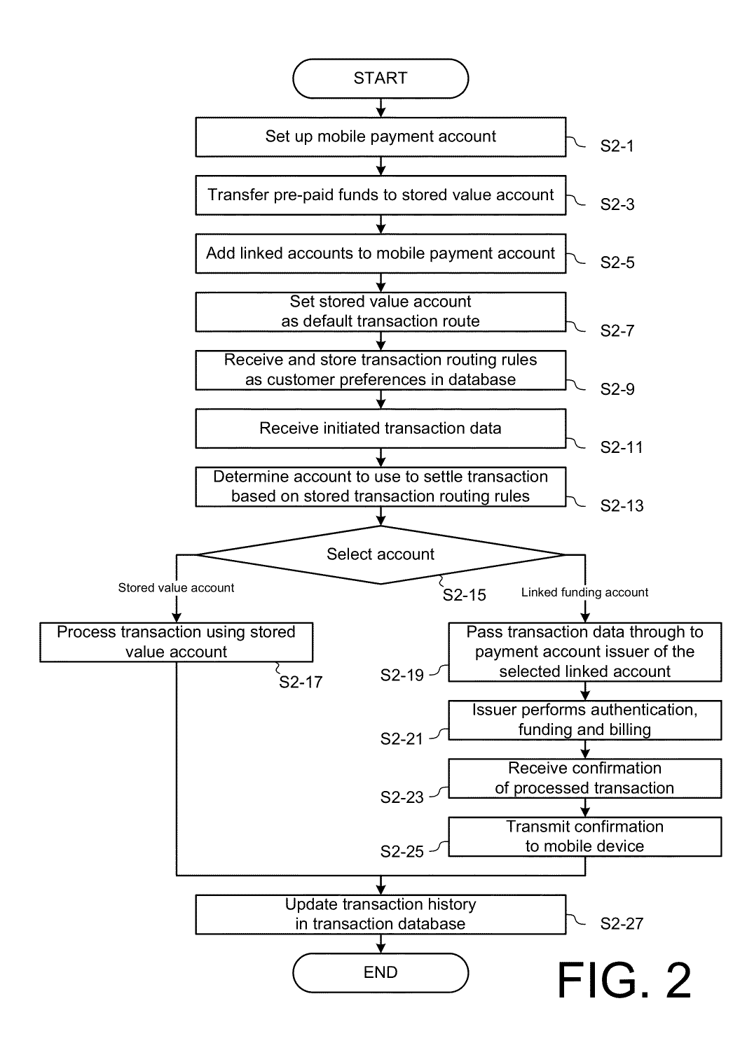

FIG. 2 is a flow diagram of a transaction routing process according to the present embodiment. As shown in FIG. 2, at step S2-1, the customer sets up a mobile payment account with the payment transaction system 100. This can be performed via the user interface 8 of the mobile device 11 or another computing device. At step S2-3, the payment authentication platform 5 processes a transfer of pre-paid funds to the stored value account in the customer's mobile payment account. At step S2-5, the customer adds one or more linked, accounts to the mobile payment account. The linked account data 19 is stored by the payment authentication platform 5 in the customer account database 21. During set up for the mobile payment account, the customer can choose to fund mobile payment transactions using a stored value account associated with the mobile handset 11 as a default selection, at step S2-7. When the customer makes a mobile initiated transaction, the stored value payment account data 23 is then used to fund the payment transaction.

After the mobile payment account is set up and prior to subsequent transactions and purchases, the customer can change from stored value funding by default to either a primary issuer “pass through” payment account or a secondary issuer “pass through” payment account. The customer can input and communicate this switch to the payment authentication platform 5 via the user interface 8. At step S2-9, the payment authentication platform 5 receives and stores the defined transaction routing rules as preferences data 17 in the customer account database 21. In this way, no changes are required at the point of sale for purchase and the payment transaction system 100 enables real-time switching of payment account funding between pass-through to stored pre-paid value for all mobile initiated payment transactions.

At step S2-11, the payment authentication platform 5 receives transaction data for a payment transaction initiated by the mobile device 11. Information associated with authentication by the authentication token is also received by the payment authentication platform 5. At step S2-13, in response to the transaction authentication performed by the authentication token and the received transaction data associated with the transaction, the payment authentication platform determines whether the stored value account or one or more or the linked accounts is to be used to settle the transaction, based on the customer defined rules stored in the preferences data 17 and/or system recommended rules. The rules may define a combination of accounts to be used to settle a transaction.

At step S2-15, the payment authentication platform 5 selects the account based on the determination, and when the selected account is the stored value account, then at step S2-17, the payment authentication platform 5 processes the transaction using the pre-paid funds of the stored value account. On the other hand, when the selected account is a linked funding account, then at step S2-19, the payment authentication platform 5 passes the transaction data through to the payment account issuer of the target payment vehicle 7 of the selected link account At step S2-21, the payment account issuer of the target payment vehicle 7 performs authorization, funding and billing, as required, to settle the transaction.

At step S2-23, the payment authentication platform 5 receives confirmation of the settled transaction from the payment account issuer of the target payment vehicle 7, and delivers payment confirmation to the customer's mobile device 11 associated with mobile payment account at step S2-25. At step S2-27, the payment authentication platform 5 updates the transaction database 10 with the settled transaction an that the transaction history from all mobile initiated funding accounts will be available for retrieval and viewing by the customer, for example, via the user interface 8 of the mobile device 11.

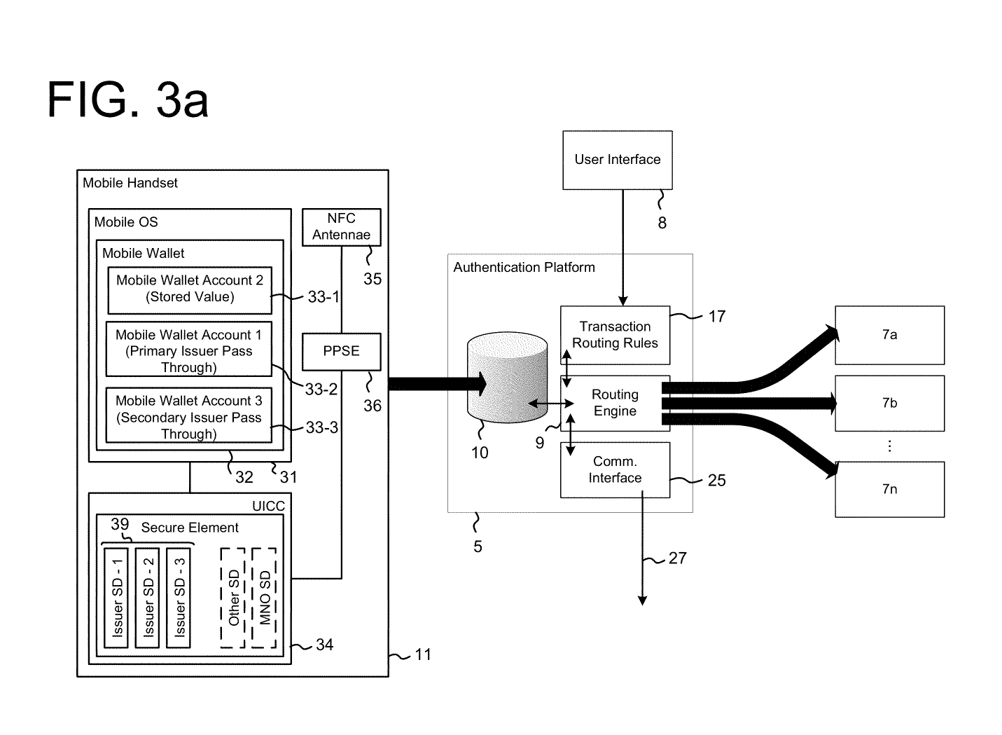

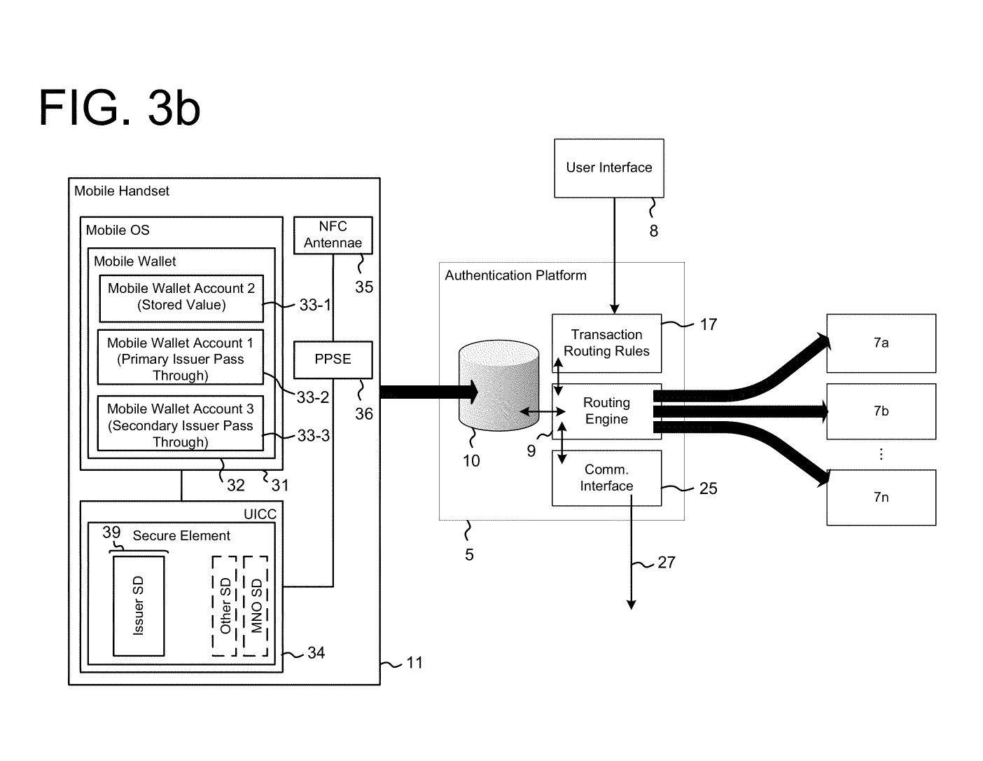

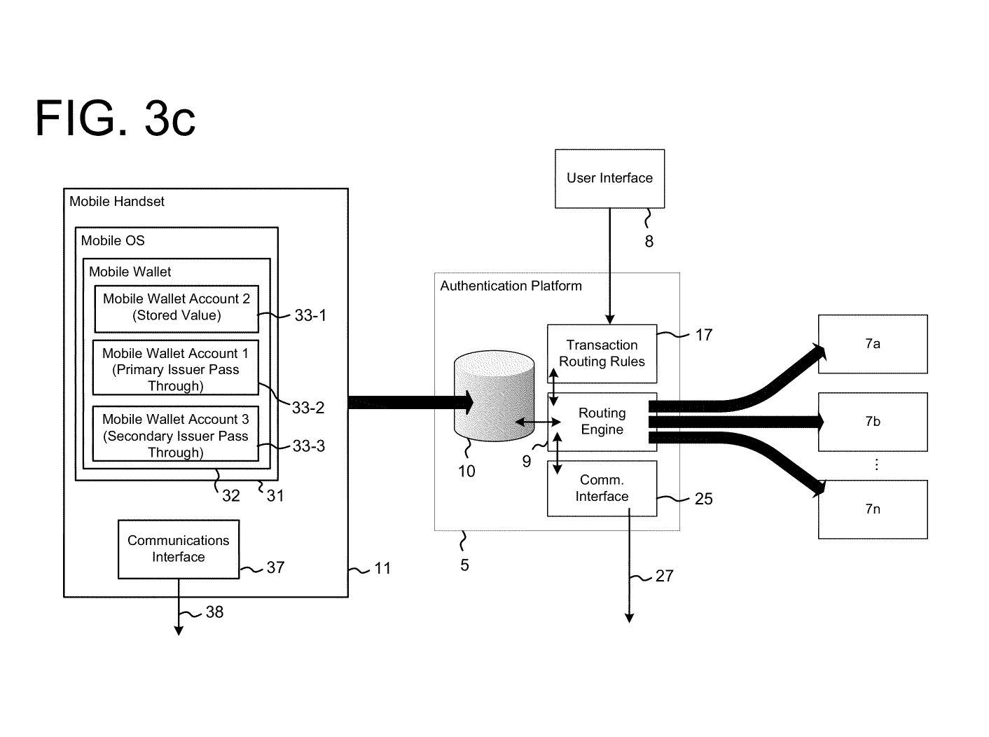

FIG. 3a is a diagram of an account management functionality of the payment transaction system 100 according to a first example of a mobile device 11, where a plurality of controlled payment accounts are provided in an issuer security domain of the mobile device 11. As shown in FIG. 3a, the mobile handset 11 includes a mobile operating system 31 and a mobile wallet 32 associated with a first payment account 33-1 having a pre-paid stored value, a second payment account 33-2 associated with a primary issuer pass-through funding account, and a third payment account 33-3 associated with a secondary issuer pass-through funding account. The mobile wallet 32 is preferably provided as application software running on the mobile operating system 31. The mobile wallet 32 accesses account data associated with each payment account 33, stored securely within respective issuer security domains (SD) 39 of a secure element 34 of the mobile handset 11. The secure element 34 is provided in a Universal Integrated Circuit Card (UICC) on the mobile handset 11 Subscriber Identity Module (SIM) or on a removable Secure Digital memory card.

As discussed above, the customer can switch from a pass-through payment account 33-2, 33-3 to the stored value first payment account 33-1 and back, by selecting the account in the mobile wallet and pointing to the appropriate security domain, and by establishing payment categories by funding account, using the user interface 8.

In the example of FIG. 3a, the mobile handset 11 also includes NFC (near field communication) antennae 35 for communication with a NFC interface of a merchant terminal, for example, to carry out contactless payment transactions via a Proximity Payment System Environment (PPSE) 36, as is known in the art. The secure element can include additional optional secure domains and Mobile Network Operator (MNO) secure domains.

FIG. 3b is a diagram of an account management functionality of the payment transaction system 100, according to a second example of a mobile device 11, where a single controlled payment account is provided in the issuer security domain 39 of the mobile device 11. As discussed above, when the customer switches between accounts in the mobile wallet 32, a real time change is made at the payment authentication platform 5 such that the routing engine 9 is adapted to process transactions based on the customer rules and preferences.

FIG. 3c is a diagram of an account management functionality of the payment transaction system 100, according to a third example of a mobile device 11 that does not include components for NFC or contactless payment transactions. In this example, the mobile wallet 32 includes a plurality of accounts 33 as discussed above, and is configured to communicate the customer defined rules and preferences to the payment authentication platform 5 using known communication interfaces 37 and channels 38, such as via the cellular telephone network or a computer network such as the Internet.

Real-Time Transaction Reporting

Since all transactions for a customer are passed through a single platform, from which these transactions can be categorized and are easily accessible, the platform 5 is able to provide real time reporting data to the customer on their current financial status, both overall and per category. This functionality is enabled as follows.

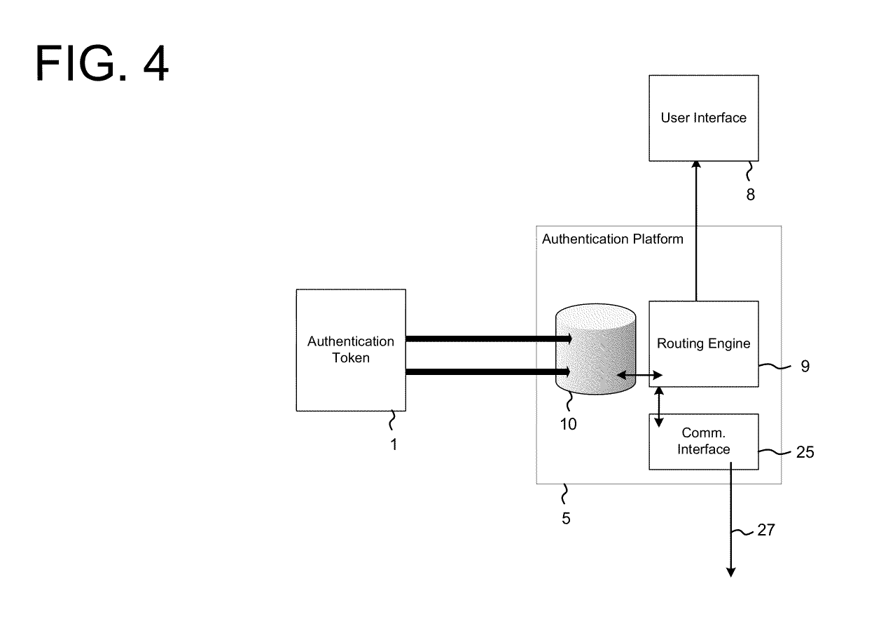

As shown in FIG. 4, the payment authentication platform 5 receives and processes both authorization and settlement transaction messages. The combination of these provides a real-time up-to-date view of all of the customer's financial activity, whether pending or posted.

The payment transaction system 100 and authentication token 1 are configured to force as many transactions as possible to be authorized online, thereby ensuring that authorizations are passed to the payment authentication platform 5 in near real time. When a settlement transaction is subsequently received, this will be reconciled against the preceding authorization, which is then removed from the customer's view to ensure a consistent single financial record.

Both authorization and settlement transactions are used in the transaction routing as described above, and categorized as described below, and both may result in an alert being sent to the customer by a selected communication channel 27, to provide timely and relevant communications regarding their transactional behavior based on preset alert preferences.

Transaction Categorization

Since transactions for a customer are passed through a single platform, the payment system 100 is able to provide automatic categorization of transactions for reporting and/or transaction routing purposes, based on stored categorization rules 41. Spending is categorised to help customers see where their money goes and make sense of spending each month. Categories may be represented in a graphical user interface by a name and a specific colour.

A default set of categories may be provided in the payment authentication platform 5. Transactions are moved automatically into specific categories on the basis of the merchant type (e.g. merchant category code) and/or value, based on the stored categorization rules 41. Transactions coming from a specific named merchant (as opposed to merchant category code) can be moved into a designated category.

Customers can create their own spending categories. The original default categories can be renamed and once saved; these changes will apply to all future transactions that fall in that category. Categories can be removed, and future transactions that would have fallen into a removed category won't have a category code unless redirected to another category.

The category that has been applied to an individual transaction can be changed. Customers can decide whether to change just that transaction or all transactions from that merchant. The routing engine 9 of the payment authentication platform 5 can thereby perform transaction routing based on defined category-based rules stored in the preferences data 17 of the customer account database 21.

As shown in FIG. 1, the payment authentication platform 5 allows the customer to enter and configure categorization rules 41 via the ‘Account Set-up and Management’ user interface 8 that enables the automatic categorization of customer transactions by the routing engine 9. Based on corresponding configured budget rules the customer's transactional behavior also alerts the customer, via a selected communication channel 27, when pre-defined values are reached.

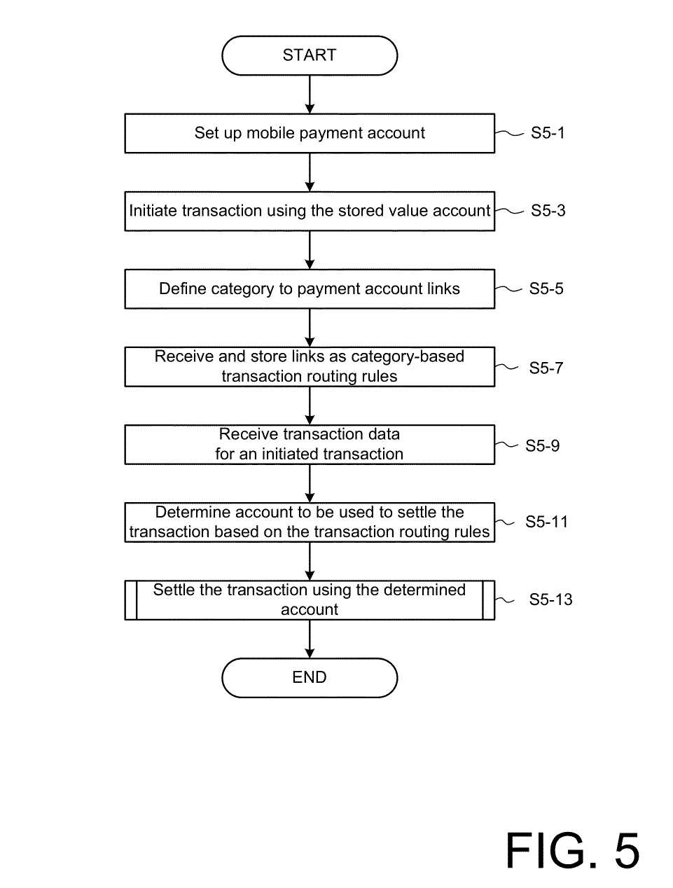

In this way, the payment transaction system 100 is configured to automatically fund specific types of transactions to selected funding accounts. FIG. 5 is a flowchart of the process of category-based routing according to an embodiment. At step S5-1, the mobile payment account is set up, and the customer has chosen to fund mobile payment transactions using a stored value account associated with the mobile handset. Consequently, at step S5-3, when the customer makes a mobile initiated transaction the stored value account is used to fund the payment transactions.

At step S5-5, prior to subsequent purchases, the customer determines that specified categories of transactions are to be funded to chosen payment vehicles or accounts defined in the mobile wallet 32. For example, using the user interface 8 of the mobile handset 11, the customer can select preferred funding from a selection of retail categories and link those categories to selected payment accounts in the mobile wallet 32. The customer can also view and select posted transactions and link the retail category of the transaction to a selected payment account for future payments from that category. At step S5-7, the customer-defined category to payment account link information is transmitted to the payment authentication platform 5 and stored as category-based transaction routing rules in the preferences data 17. In this way, no changes are required at the point of sale for purchase.

At step S5-9, the payment authentication platform 5 receives transaction data for a payment transaction initiated by the mobile device 11. Information associated with authentication by the authentication token is also received by the payment authentication platform 5. At step S5-11, in response to the transaction authentication performed by the authentication token 1 and the received transaction data associated with the transaction, the payment authentication platform 5 determines whether the stored value account or one or more or the linked accounts is to be used to settle the transaction, based on the customer defined categorization rules stored in the preferences data 17. At step S5-13, the payment authentication platform 5 proceeds to settle the transaction using the selected account as discussed above in steps S2-15 to S2-25.

The present payment transaction system facilitates a number of customer tools to assist with managing money in a simpler way, for example, by budget management, and product option recommendations to save money. All transaction and categorization data are made available in an open industry format such that customers and users can enhance the system through other ‘bolt on’ benefits using other 3rd party developed applications and functions.

User Controlled Transaction Routing

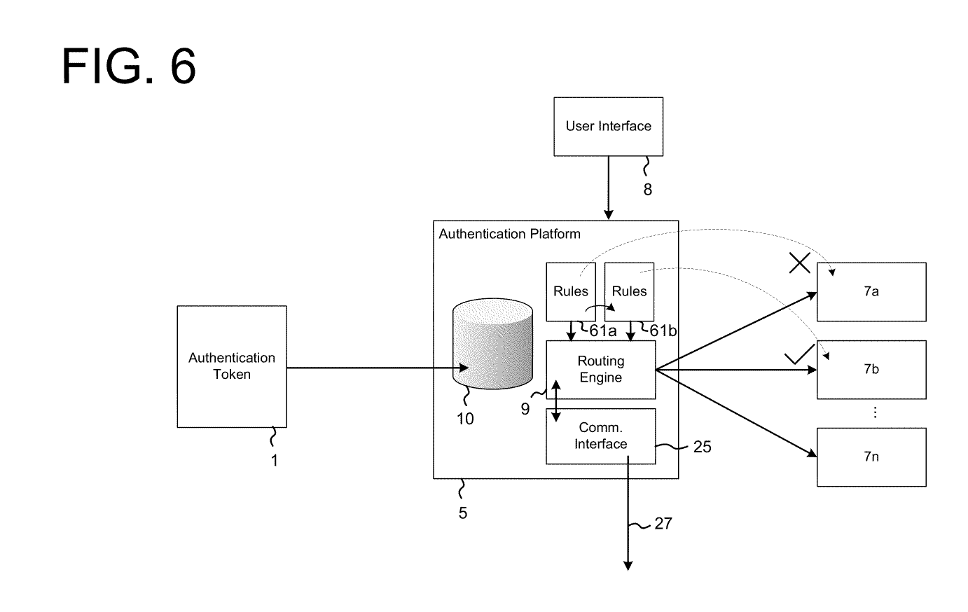

As shown in FIG. 6, the ‘Account Set-up and Management’ online user interface 8 allows the user to manually over-ride the routing rules 61a applied on an individual transaction-by-transaction basis to reroute a transaction from one payment vehicle 7a to another 7b, according to a user selected routing 61b. Certain regulatory or business rules will also be applied to govern how this functionality can be used.

The ‘Account Set-up and Management’ online user interface 8 preferably provides a graphical user interface allowing the user to select a transaction and move it to a selected payment vehicle 7, for example using a ‘drag and drop’ action.

The user control and/or the automated routing may combine multiple original transactions into one transaction for onward routing to the payment vehicle, or may split an individual transaction for routing to multiple payment vehicles.

Straight-Through Authorization

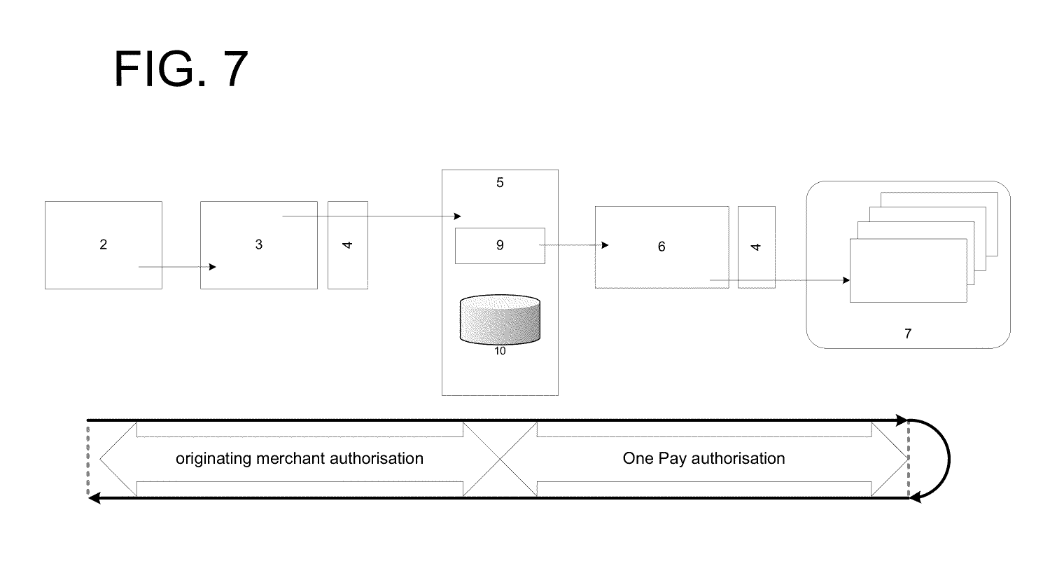

FIG. 7 shows a straight-through authorization function, in which the payment authentication platform 5, via the routing engine 9 authorizes the transaction initiated by the merchant 2 in conjunction with the merchant acquirer network 3 based on onward authorization from the target payment vehicle 7 in conjunction with the second merchant 6.

Holding Authorization

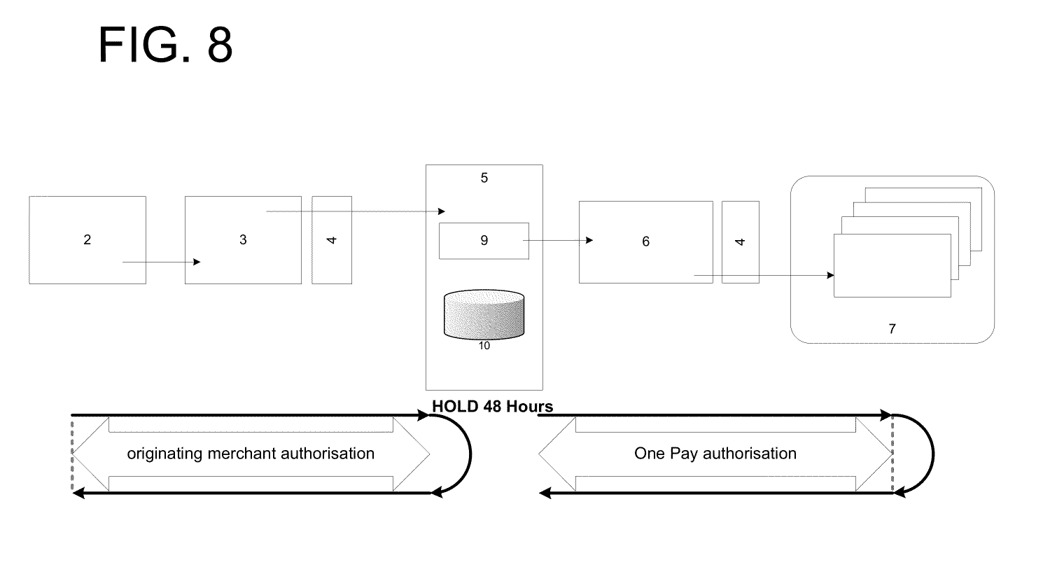

FIG. 8 shows a holding authorization function, in which the payment authentication platform 5, via the routing engine 9, authorizes the originating transaction up-front to the originating merchant 2 in conjunction with the merchant acquirer network 3, and delays seeking authorization with the target payment vehicle 7, in conjunction with the second merchant 6, after a predefined period, such as 48 hours.

Straight-Through Settlement

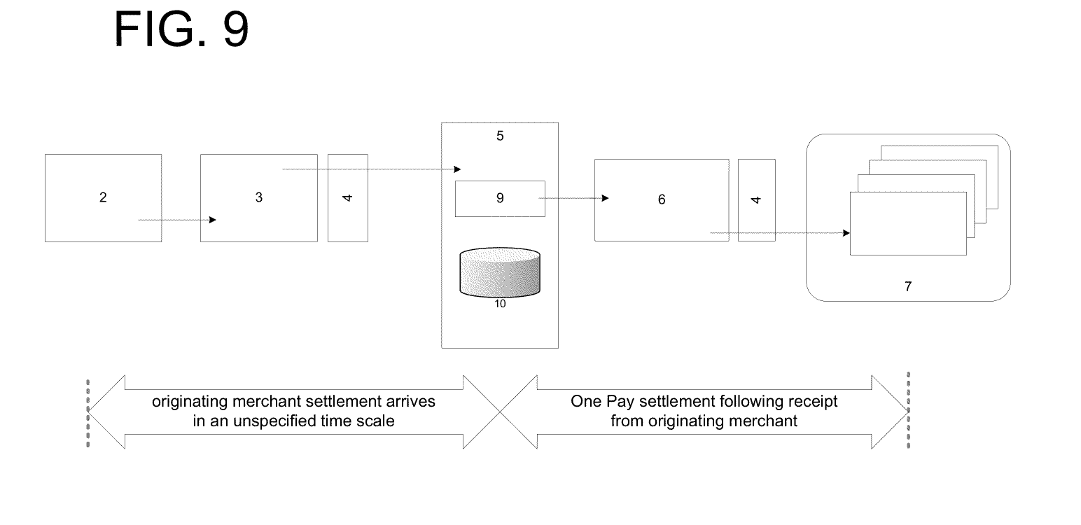

FIG. 9 shows a straight-through settlement function, in which the payment authentication platform 5, via the routing engine 9, settles a transaction with the target payment vehicle 7, in conjunction with the second merchant 6, as soon as the originating merchant 2, in conjunction with the merchant acquirer network 3, settles with the payment authentication platform 5.

Holding Settlement

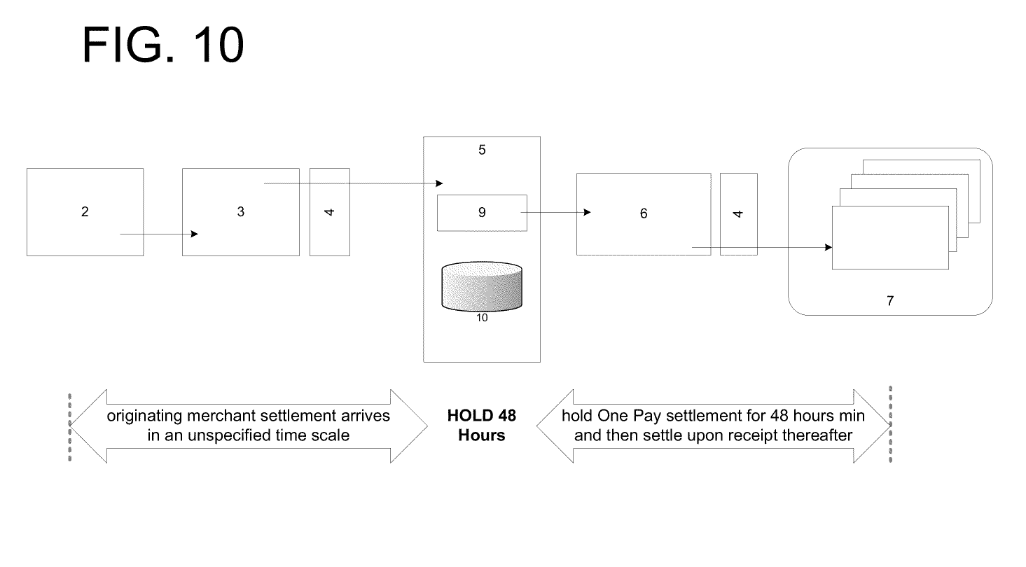

FIG. 10 shows a holding settlement function, in which the payment authentication platform 5, via the routing engine 9, settles with the target payment vehicle 7, in conjunction with the second merchant 6, after a predefined period, such as 48 hours, or after the originating merchant 2, in conjunction with the merchant acquirer network 3, settles, whichever is the later.

Computer Systems

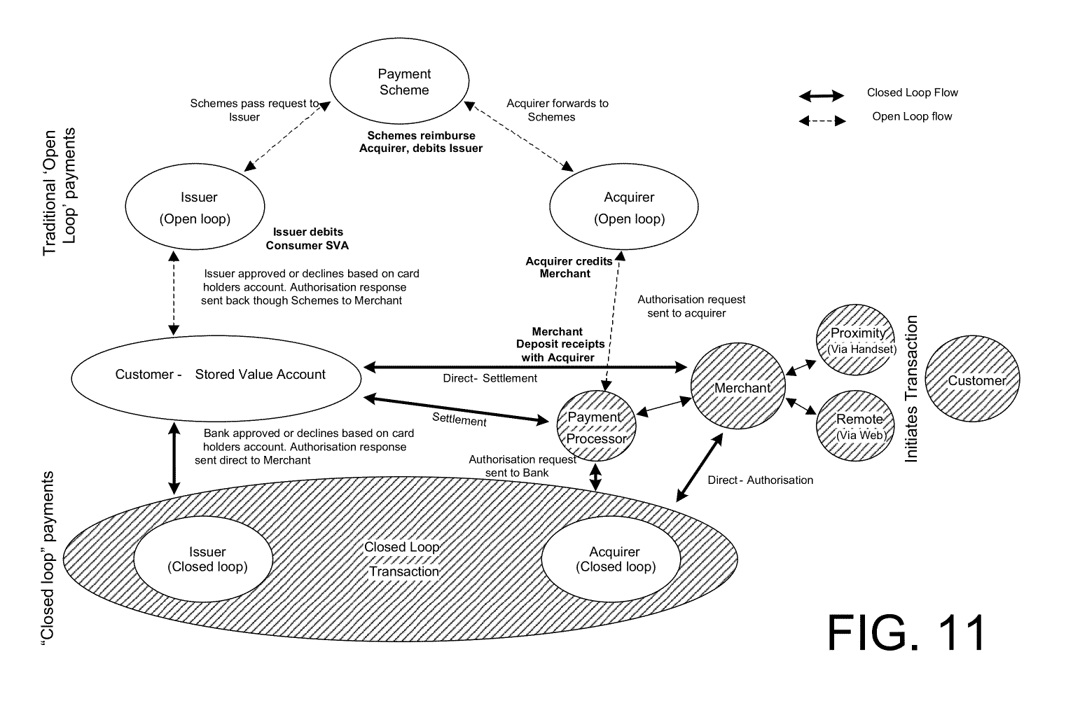

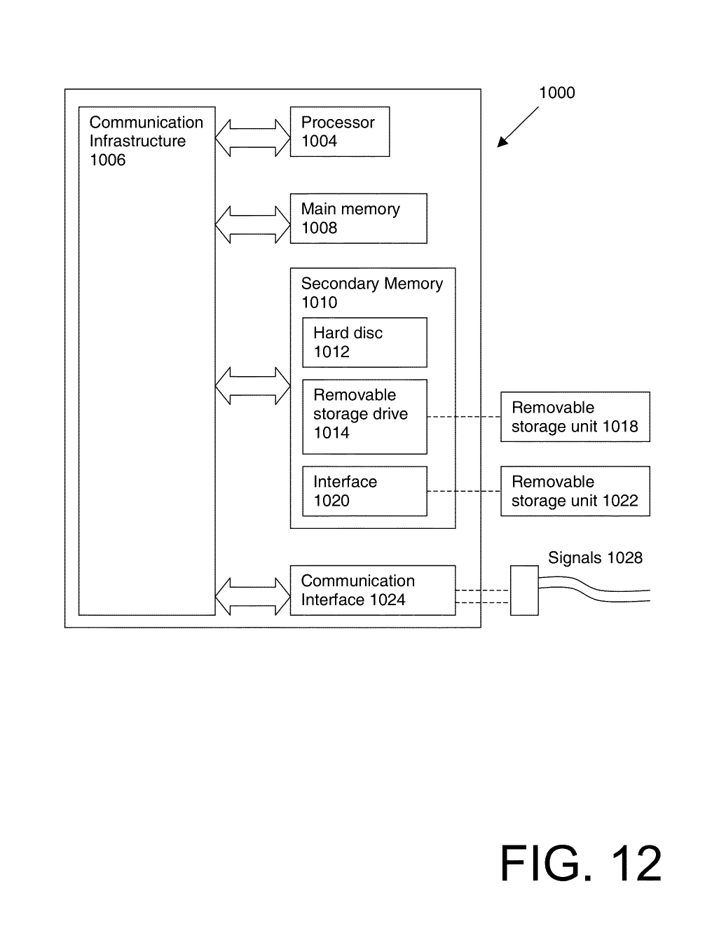

The entities described herein, such as the payment authentication platform, may be implemented by computer systems such as a computer system 1000 as shown in FIG. 11. Embodiments of the present invention may be implemented as programmable code for execution by the computer system 1000. After reading this description, it will become apparent to a person skilled in the art how to implement the invention using other computer systems and/or computer architectures.

The computer system 1000 includes one or more processors, such as processor 1004. The processor 1004 may be any type of processor, including but not limited to a special purpose or a general-purpose digital signal processor. The processor 1004 is connected to a communication infrastructure 1006 (for example, a bus or a network). Various software implementations are described in terms of this exemplary computer system. After reading this description, it will become apparent to a person skilled in the art how to implement the invention using other computer systems and/or computer architectures.

The computer system 1000 also includes a main memory 1008, preferably a random access memory (RAM), and may also include a secondary memory 610. The secondary memory 1010 may include, for example, a hard disk drive 1012 and/or a removable storage drive 1014, representing a floppy disk drive, a magnetic tape drive, an optical disk drive, etc. The removable storage drive 1014 reads from and/or writes to a removable storage unit 1018 in a well-known manner. The removable storage unit 1018 can be a floppy disk, magnetic tape, optical disk, etc., which is read by and written to a removable storage drive 1014. As will be appreciated, the removable storage unit 618 includes a computer usable storage medium having stored therein computer software and/or data.

In alternative implementations, the secondary memory 1010 may include other similar means for allowing computer programs or other instructions to be loaded into the computer system 1000. Such means may include, for example, a removable storage unit 1022 and an interface 1020. Examples of such means may include a program cartridge and a cartridge interface (such as that previously found in video game devices), a removable memory chip (such as an EPROM, or PROM, or flash memory) and associated socket, and other removable storage units 1022 and interfaces 1020 which allow software and data to be transferred from the removable storage unit 1022 to the computer system 1000. Alternatively, the program may be executed and/or the data accessed from the removable storage unit 1022, using the processor 1004 of the computer system 1000.

The computer system 1000 may also include a communication interface 1024. The communication interface 1024 allows software and data to be transferred between the computer system 1000 and external devices. Examples of the communication interface 1024 may include a modem, a network interface (such as an Ethernet card), a communication port, a Personal Computer Memory Card International Association (PCMCIA) slot and card, etc. Software and data transferred via the communication interface 1024 are in the form of signals 1028, which may be electronic, electromagnetic, optical, or other signals capable of being received by the communication interface 1024. These signals 1028 are provided to the communication interface 1024 via a communication path 1026. The communication path 1026 carries signals 1028 and may be implemented using wire or cable, fibre optics, a phone line, a wireless link, a cellular phone link, a radio frequency link, or any other suitable communication channel. For instance, the communication path 1026 may be implemented using a combination of channels.

The terms “computer program medium” and “computer usable medium” are used generally to refer to media such as a removable storage drive 1014, a hard disk installed in a hard disk drive 1012, and signals 1028. These computer program products are means for providing software to the computer system 1000. However, these terms may also include signals (such as electrical, optical or electromagnetic signals) that embody the computer program disclosed herein.

Computer programs (also called computer control logic) are stored in the main memory 1008 and/or the secondary memory 1010. Computer programs may also be received via the communication interface 1024. Such computer programs, when executed, enable the computer system 1000 to implement embodiments of the present invention as discussed herein. Accordingly, such computer programs represent controllers of the computer system 1000. Where the embodiment is implemented using software, the software may be stored in a computer program product and loaded into the computer system 1000 using the removable the storage drive 1014, the hard disk drive 1012, or the communication interface 1024, to provide some examples.

Alternative embodiments may be implemented as control logic in hardware, firmware, or software or any combination thereof.

What is claimed is:

1. A payment transaction system, comprising:
a payment authentication platform providing a first payment account associated with an authentication token, the authentication token being associated with a user, the payment authentication platform storing:
stored value payment account information corresponding to a stored value payment account having a pre-paid stored value; and
account information corresponding to a plurality additional accounts associated with the first payment account,
wherein in response to a transaction authentication performed by the authentication token and a transaction data associated with a transaction, the payment authentication platform selects at least one of the stored value payment account and the plurality of additional accounts associated with the first payment account, to settle the transaction with the at least one of the stored value payment account and the plurality of additional accounts associated with the first payment account.

2. The system of claim 1, wherein the payment authentication platform selects an account automatically according to one or more predetermined criteria.

3. The system of claim 2, wherein the one or more of predetermined criteria are configurable by the user.

4. The system of claim 3, wherein the one or more of the predetermined criteria are configurable by means of a user interface.

5. The system of claim 2, wherein one or more of the predetermined criteria is based on the transaction.

6. The system of claim 5, wherein the payment authentication platform categorizes the transaction according to one or more predetermined categorization rules.

7. The system of claim 6, wherein the one or more of the categorization rules is configurable by the user.

8. The system of claim 6, wherein the payment authentication platform generates a report or alert to the user based on the categorization rules.

9. The system of claim 1, wherein the payment authentication platform selects an account according to a selection by the user.

10. The system of claim 9, wherein the payment authentication platform stores the user selection of an account as user preference data in a database.

11. The system of claim 1, wherein the payment authentication platform settles a transaction with a selected stored value payment account by deducting a transaction amount from a pre-paid stored value.

12. The system of claim 1, wherein the payment authentication platform settles a transaction with a selected additional account associated with the first payment account by passing transaction data through to an account issuer associated with the additional account.

13. The system of claim 1, wherein the payment authentication platform delays settlement of a transaction for a period to enable the user to select one or more of the accounts with which to settle the transaction during the period.

14. The system of claim 13, wherein the payment authentication platform selects one or more of the additional accounts automatically if the user does not select one or more of the additional accounts within the period.

15. The system of claim 13, including a user interface enabling the user to select one or more of the one or more of the additional accounts.

16. The system of claim 15, wherein said the user interface is a graphical user interface.

17. The system of claim 16, wherein the graphical user interface is a graphical representation of each delayed transaction and of each of the one or more of the additional accounts, and allows the user to drag a delayed transaction to an account and thereby select the account for settlement of a pending transaction.

18. The system of claim 1, wherein the payment authentication platform is arranged to divide the transaction into multiple fractions, and to settle each fraction with a respective different one of the plurality of additional accounts.

19. The system of claim 18, wherein the payment authentication platform divides the transaction in response to an interaction by the user.

20. The system of claim 18, wherein the payment authentication platform divides the transaction according to a predetermined criterion.

21. The system of claim 1, wherein the payment authentication platform combines a plurality of the transactions into a single settlement with a selected one of the additional accounts.

22. The system of claim 21, wherein the payment authentication platform divides transaction in response to a user interaction.

23. The system of claim 21, wherein the payment authentication platform divides the transaction according to a predetermined criterion.

24. The system of claim 1, wherein the payment authentication platform generates a report or alert to the user in response to a transaction.

25. The system of claim 24, wherein the report or alert is generated according to one or more rules configurable by the user.

26. The system of claim 1, wherein the authentication token comprises one of: a card, or a wireless communication device.

27. A payment transaction system, comprising:
a payment authentication platform including an electronic wallet associated with a user, the payment platform storing payment information corresponding to the electronic wallet including a pre-paid stored value, information corresponding to a plurality of funding accounts linked to the electronic wallet, and one or more rules defined by the user for transaction routing using the electronic wallet, wherein the payment authentication platform settles a transaction with at least one of the pre-paid stored value or one or more additional accounts based on the one or more rules defined by the user for transaction routing.

28. A method of conducting a payment transaction with a mobile wallet, comprising:
a. storing payment information for a plurality of secondary accounts associated with the mobile wallet;
b. storing pre-paid payment information for a stored value payment account associated with the mobile wallet;
c. authenticating a transaction for a primary account associated with a user by an authentication token associated with the user;
d. receiving transaction data associated with the transaction;
e. selecting one or more of the stored value payment account or the plurality of secondary accounts associated with the mobile wallet, and
f. settling the transaction with the one or more of the stored value payment account or the plurality of secondary accounts associated with the mobile wallet.

29. A method of conducting a payment transaction, comprising:
a. storing payment information corresponding to an electronic wallet including a pre-paid stored value, information corresponding to a plurality of funding accounts linked to the mobile wallet, and one or more rules defined by a user for transaction routing using the electronic wallet;
b. processing the payment transaction with at least one of the pre-paid stored values or the plurality of funding accounts based on the rules defined by the user for the transaction routing.

30. A computer program comprising program code for:
g. storing payment information for a plurality of secondary accounts associated with the mobile wallet;
h. storing pre-paid payment information for a stored value payment account associated with the mobile wallet;
i. authenticating a transaction for a primary account associated with a user by an authentication token associated with the user;
j. receiving transaction data associated with the transaction;
k. selecting one or more of the stored value payment account or the plurality of secondary accounts associated with the mobile wallet, and
l. settling the transaction with the selected one or more of the stored value payment account or the plurality of secondary accounts associated with the mobile wallet.
